(19) United States
(12) Patent Application Publication
(10) Pub. No.: US 2026/0353021 A1
(43) Pub. Date: Nov. 5, 2026

(54) SPEAKER PORT BLOCKING DETECTION

(71) Applicant: QUALCOMM Incorporated, San Diego, CA (US)

(72) Inventors: Hocine MERABTI, San Diego, CA (US); Hui-Ya Liao NELSON, San Diego, CA (US); Matthew ZIVNEY, San Diego, CA (US); Shreyas Srikanth PAYAL, Carlsbad, CA (US); Eddie CHOY, Carlsbad, CA (US); Louis Dominic OLIVEIRA, San Diego, CA (US); Guoqing MIAO, San Diego, CA (US)

(21) Appl. No.: 19/195,669

(22) Filed: Apr. 30, 2025

(51) Int. Cl. H04R 29/00

(52) U.S. Cl. CPC H04R 29/001; H04R 2499/11

(57) ABSTRACT

The present disclosure provides techniques for detecting the presence of a blockage of a speaker port and/or implementing one or more corrective actions for an apparatus having a blocked speaker port. An example method includes obtaining at least one of a current signal or a voltage signal associated with an output signal for a speaker; detecting a presence of a blockage of a speaker port of the speaker based on the at least one of the current signal or the voltage signal; and implementing a corrective action based on the presence of the blockage of the speaker port.

### INTRODUCTION

### Field of the Disclosure

Aspects of the present disclosure relate to techniques for detecting and/or correcting a blocked speaker port.

### Description of Related Art

Electronic devices including handheld, portable, and wearable devices can include one or more speakers with corresponding speaker ports that enable sound from the one or more speakers to be output from the electronic device. From time to time, electronic devices such as handheld, portable, and wearable devices can accumulate debris, liquid, or the like in, on, or around the speaker ports. The presence and accumulation of debris, liquid, or the like can cause the sound output from one or more speakers to be negatively affected, for example, by decreasing the loudness or degrading the quality of the sound output.

The negatively impacted sound output may not always be readily perceivable by a user, the user may not know which one of the speaker ports is blocked, and/or the user may not know what corrective action should be implemented.

Accordingly, there is a need for detecting and correcting a blocked speaker port on electronic devices, including but not limited to handheld, portable, and wearable devices.

### SUMMARY

Certain aspects provide a method for detecting and/or correcting a blocked speaker port of an apparatus. The method includes obtaining at least one of a current signal or a voltage signal associated with an output signal for a speaker; detecting a presence of a blockage of a speaker port of the speaker based on the at least one of the current signal or the voltage signal; and implementing a corrective action based on the presence of the blockage of the speaker port.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an electronic device with unblocked and blocked speaker ports and an illustrative kinetic mass (Kms) value corresponding to speaker output when the speaker port is blocked and unblocked.

FIG. 2 depicts an illustrative electronic device, such as mobile phone.

FIG. 3 depicts an illustrative speaker driver circuit of the electronic device.

FIG. 4 depicts aspects of an example method for detecting a blockage of a speaker port and implementing a corrective action.

FIG. 5 depicts aspects of an example method for detecting and/or correcting a blocked speaker port of an apparatus.

FIG. 6 depicts aspects of an example apparatus.

### DETAILED DESCRIPTION

Aspects of the present disclosure provide apparatuses, methods, processing systems, and computer-readable mediums related to techniques for detecting and/or correcting a blocked speaker port. For purposes of describing aspects of the techniques for detecting and/or correcting the blocked speaker port of an electronic device herein, the electronic device will be a mobile phone. However, it is understood that the techniques described herein can be implemented on or with other devices, such as other handheld, portable, or wearable devices.

Mobile phones typically include speaker ports formed with the frame or case of the mobile phone that enable sound to be transmitted from the one or more speakers located within the case of the mobile phone to the environment outside the mobile phone. Mobile phones, like other electronic devices, are typically carried by a person and introduced to various environments that are not always free of debris. For example, mobile phones are typically carried in the pocket or handbag of the user. Each of these environments include plenty of loose materials that can accumulate on, in, and/or around speaker ports of the mobile phone.

The accumulation of debris, such as liquid or the like, can cause the sound output from one or more speakers to be negatively affected, for example, by decreasing the loudness or degrading the quality of the sound output. The negatively impacted sound output may not always be perceivable by a user, the user may not know which one of the speaker ports is blocked, and/or the user may not know what corrective action should be implemented.

In certain aspects, the techniques described herein provide processes for detecting the presence of a blockage of the speaker port and/or processes for implementing corrective action to reduce or remove the blockage. In certain aspects, processes described can be extended to also determine whether a microphone is muted.

Certain aspects will now be described in more detail with reference to the figures.

### Example Electronic Device Speaker Port Blockage

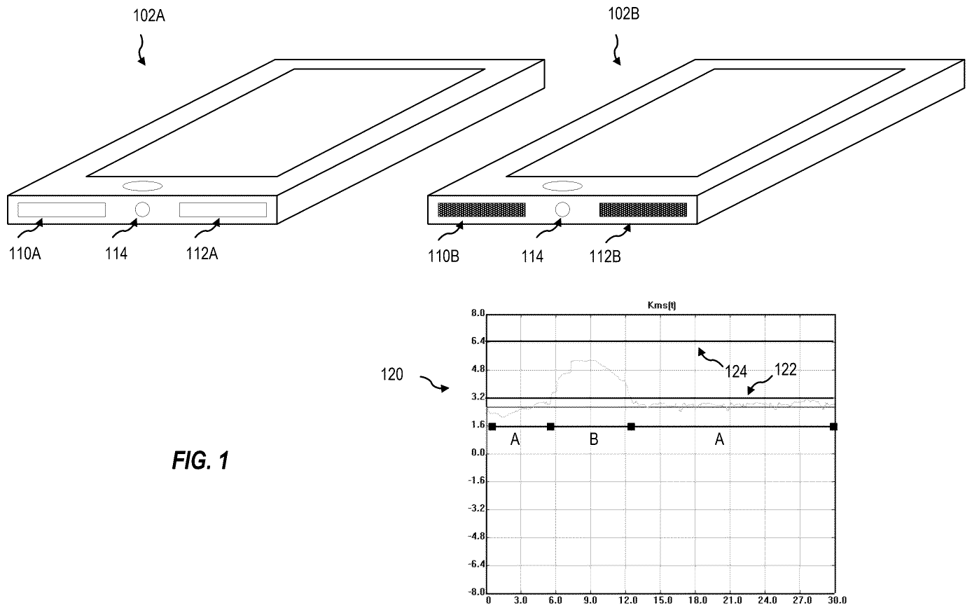

FIG. 1 depicts an illustrative electronic device depicted as a mobile phone 102. The mobile phone 102 is depicted in two different states. The first state of the mobile phone 102A is depicted with unblocked speaker ports 110A and 112A which have corresponding speakers (not depicted in FIG. 1) that generate a sound output. The second state of the mobile phone 102B is depicted with blocked speaker ports 110B and 112B which have corresponding speakers (not depicted in FIG. 1) that generate a sound output. In the second state, the sound output is negatively impacted by the blockage. The mobile phone 102 may also include a port 114 corresponding to the microphone, which in some cases may be positioned near, for example, on the same surface as the speaker ports.

The illustrative diagram 120 depicts the change in the kinetic mass (Kms) value corresponding to the speaker output. When the speaker port (e.g., 110A and 112A, FIG. 1) is not blocked and the corresponding speaker is outputting sound, the Kms value (e.g., signal A depicted in diagram 120) remains below a threshold Kms value (e.g., the first threshold 122) that corresponds to the stiffness of the suspension of the speaker generating the sound output. However, when the speaker port (e.g., 110B and 112B, FIG. 1) is blocked and the corresponding speaker is outputting sound, the Kms value (e.g., signal B depicted in diagram 120) exceeds the threshold Kms (e.g., the first threshold 122) that corresponds to the stiffness of the suspension of the speaker generating the sound output. As discussed in more detail herein, by monitoring the electrical signal values that drive the speaker to generate the sound output, the presence of a blockage of the speaker port can be detected. In some instances, not only can the presence of a blockage be detected, but the type of blockage may be classified so that a corresponding corrective action can be determined and implemented.

In certain aspects, the electrical signal value that is monitored is the current provided to drive the speaker, the voltage provided to drive the speaker, or a combination of voltage and current. In certain aspects, a secondary sensor, such as a pressure sensor may be implemented within the speaker port cavity (e.g., between the speaker and the opening of the speaker port) to measure the pressure changes within the speaker port cavity. However, depending on the volume and frequency of the sound that is generated by the speaker, an external sensor can interfere with the volume and quality of the output sound. Accordingly, additional structural design considerations may be needed to implement the external sensor.

Referring to the aspects the utilize the electrical signal value that is provided to drive the speaker, implementations of such aspects may take advantage of components that are already implemented into the speaker driver circuitry instead of implementing additional components.

It should be understood that while the illustrative example discussed herein includes a mobile phone 102, the techniques described herein can be applied to other types of electronic devices.

### Electronic Device and System

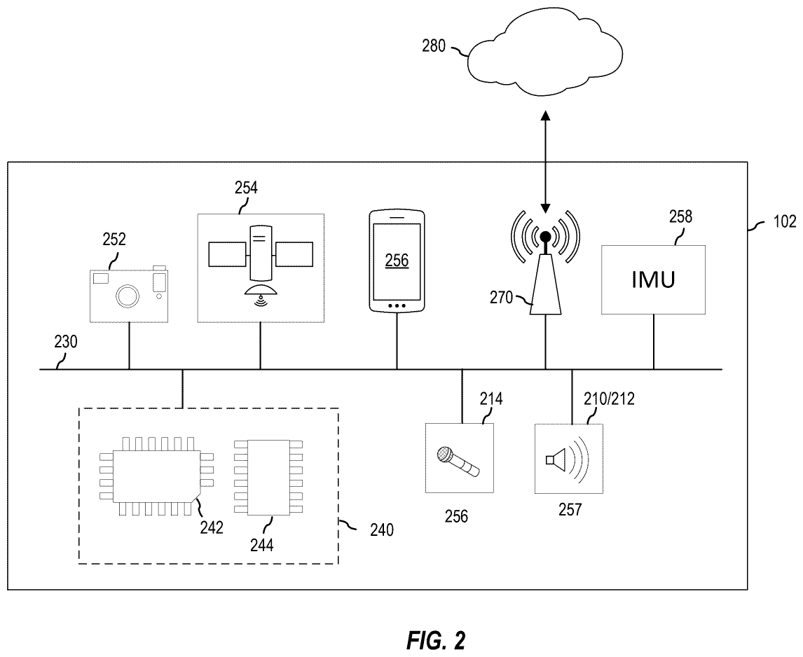

FIG. 2 depicts an illustrative electronic device, such as the mobile phone 102 depicted in FIG. 1, corresponding to aspects described herein. The mobile phone 102 depicted in FIG. 2 is depicted by way of an example schematic including components and a computing device. Not every mobile phone is required to be equipped with the same set of components or resources, nor required to be configured with the same set of systems for detecting and implementing corrective actions for a blockage of a speaker port. FIG. 2 only provides one example configuration of components and systems.

FIG. 2 provides an example schematic of the mobile phone 102 including a variety of sensor resources, which may be utilized by the mobile phone 102 to detect a blockage of a speaker port and implement a corrective action to remove or reduce the blockage of the speaker port. For example, the mobile phone 102 may include a computing device 240 comprising one or more processors 242 and a non-transitory computer readable memory 244 (e.g., corresponding to one or more memories), one or more image sensors 252, a Global Positioning System (GPS) unit 254, a display 256, one or more microphones 214, one or more speakers 210, 212, an inertial measurement unit (IMU) 258, and network interface hardware 270. The components of the mobile phone 102 are merely examples as some mobile phones 102 may have more or less components and/or different sensors for perceiving the environment. These and other components of the mobile phone 102 may be communicatively connected to each other via a communication path 230. It should be noted that non-transitory computer readable memory 244 may include volatile and/or non-volatile memory or storage.

The communication path 230 may be formed from any medium that is capable of transmitting a signal such as, for example, conductive wires, conductive traces, optical waveguides, or the like. The communication path 230 may also refer to the expanse in which electromagnetic radiation and their corresponding electromagnetic waves traverse. Moreover, the communication path 230 may be formed from a combination of mediums capable of transmitting signals. In certain aspects, the communication path 230 comprises a combination of conductive traces, conductive wires, connectors, and buses that cooperate to permit the transmission of electrical data signals to components such as processors, memories, sensors, input devices, output devices, and communication devices. Accordingly, the communication path 230 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The computing device 240 may be any device or combination of components comprising one or more processors 242 and one or more memories 244. The one or more processors 242 may be any device capable of executing the processor-executable instructions stored in the one or more memories 244. Accordingly, the one or more processors 242 may be an electric controller, an integrated circuit, a microchip, a computer, or any other computing device. The one or more processors 242 are communicatively coupled to the other components of the mobile phone 102 by the communication path 230. Accordingly, the communication path 230 may communicatively couple any number of processors 242 with one another, and allow the components coupled to the communication path 230 to operate in a distributed computing environment. Specifically, each of the components may operate as a node that may send and/or receive data.

The one or more memories 244 may comprise random access memory (RAM), read-only memory (ROM), flash memories, hard drives, or any non-transitory memory device capable of storing processor-executable instructions such that the processor-executable instructions can be accessed and executed by the one or more processors 242. The machine-readable instruction set may comprise logic or algorithm(s) written in any programming language of any generation (e.g., 1GL, 2GL, 3GL, 4GL, or 5GL) such as, for example, machine language that may be directly executed by the one or more processors 242, or assembly language, object-oriented programming (OOP), scripting languages, microcode, etc., that may be compiled or assembled into processor-executable instructions and stored in the one or more memories 244. Alternatively, the processor-executable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. The one or more processors 242 and the one or more memories 244 may be collectively referred to herein as a processing system. A processing system may additionally include one or more other components of FIG. 2.

The mobile phone 102 may further include one or more image sensors 252. The one or more image sensors 252 may be any device having an array of sensing devices (e.g., a CCD array or active pixel sensors) capable of detecting radiation in an ultraviolet wavelength band, a visible light wavelength band, or an infrared wavelength band. The one or more image sensors 252 may have any resolution. The one or more image sensors 252 (also referred to as a camera) may include an omni-direction camera and/or a panoramic camera. In certain aspects, one or more optical components, such as a mirror, fish-eye lens, or any other type of lens may be optically coupled to the image sensors 252. The image data collected by the image sensors 252 may be stored in the one or more memories 244.

Still referring to FIG. 2, a GPS unit 254 may be coupled to the communication path 230 and communicatively coupled to the computing device 240 of the device 202. The GPS unit 254 is capable of generating location information indicative of the location of the mobile phone 102 by receiving one or more GPS signals from one or more GPS satellites. The GPS signal communicated to the computing device 240 via the communication path 230 may include location information comprising a National Marine Electronics Association (NMEA) message, a latitude and longitude data set, a street address, a name of a known location based on a location database, or the like. Additionally, the GPS unit 254 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. The sensor data collected by the GPS unit 254 may be stored in the one or more memories 244.

The mobile phone 102 also includes a display 256. The display 256 may be configured to provide a visual output. The display 256 is coupled to the communication path 230. Accordingly, the communication path 230 communicatively couples the display 256 with other components of the mobile phone 102. The display 256 may include any medium capable of transmitting an optical output such as, for example, a cathode ray tube, light emitting diodes, a liquid crystal display, a plasma display, or the like. Additionally, the display 256 may be the display 256 of a portable personal device such as a smart phone, tablet, laptop or other electronic device. Additionally, it is noted that the display 256 can include one or more processors 242 and one or more memories 244

The device 202 may also have a speaker 210, 212 or more than one speaker. The speaker 210, 212 (i.e., an audio output device) is coupled to the communication path 230 and communicatively coupled to the one or more processors 242. The speaker 210, 212 transforms electrical signals from the speaker driver circuit and the one or more processors 242 of the computing device 240 into mechanical vibrations producing a sound output. The speaker 210, 212 of the mobile phone 102 may have a corresponding speaker port (e.g., 110A and 112A or 110B and 110B depicted in FIG. 1).

The mobile phone 102 may also include one or more microphones 214 that is coupled to the communication path 230 and communicatively coupled to the one or more processors 242. The one or more microphones 214 may be any device capable of transforming a mechanical vibration associated with sound into an electrical signal indicative of the sound. The one or more microphones 214 may be used to pick up audio such as voices and other sounds within the environment. It should be understood that some embodiments may not include the one or more microphones 214.

The mobile phone 102 may include an inertial measurement unit (IMU) 258. The IMU 258 is an electronic device that measures and reports an apparatus's specific force, angular rate, and sometimes the orientation of the apparatus, using a combination of accelerometers, gyroscopes, and sometimes magnetometers. The sensor data collected by the IMU 258 may be stored in the one or more memories 244.

Still referring to FIG. 2, a mobile phone 102 can be equipped with communication systems. Some of the communication systems rely on network interface hardware 270. The network interface hardware 270 may be coupled to the communication path 230 and communicatively coupled to the computing device 240. The network interface hardware 270 may be any device capable of transmitting and/or receiving data with a network 280 or directly with another device. Accordingly, network interface hardware 270 can include a communication transceiver for sending and/or receiving any wired or wireless communication. For example, the network interface hardware 270 may include an antenna, a modem, LAN port, Wi-Fi card, WiMax card, mobile communications hardware, near-field communication hardware, satellite communication hardware and/or any wired or wireless hardware for communicating with other networks and/or devices. In certain aspects, network interface hardware 270 includes hardware configured to operate in accordance with the Bluetooth wireless communication protocol. In certain aspects, network interface hardware 270 may include a Bluetooth send/receive module for sending and receiving Bluetooth communications to/from a network 280 and/or another device 290. In certain aspects, the network interface hardware 270 may implement a radio access technology (RAT) such as a 5G or 6G RAT. For example, the network interface hardware 270 may provide apparatus-to-apparatus (A2A) connectivity, access network connectivity, sidelink connectivity (e.g., using a PC5 interface), or the like.

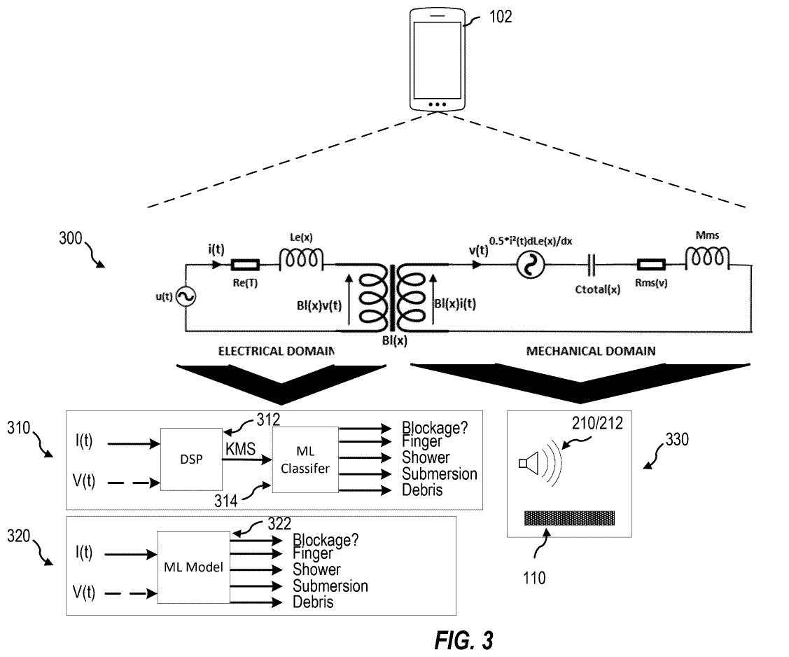

FIG. 3 depicts an illustrative speaker driver circuit 300 of the electronic device, such as the mobile phone 102. The speaker driver circuit 300 is a lumped-parameter model of an implementation of a component level speaker driver circuit 300.

The speaker driver circuit 300 may be operatively coupled to a digital signal processing component 310 and/or a machine learning model component 320. The digital signal processing component 310 and the machine learning model component 320 may be configured to obtain a current signal and/or a voltage signal corresponding to the electrical signal of the speaker driver circuit 300 that drives the mechanical domain of the speaker circuit, such as the speaker 210, 212 depicted in FIG. 2. The electrical signal causes the speaker 210, 212 generate a sound output. In certain aspects, the mobile phone 102 may include circuitry and/or one or more processors and one or more memories configured to obtain the current signal, I(t), associated with the output signal for the speaker. In certain aspects, the voltage signal, V(t), may also be obtained. The current signal, I(t), may be obtained by monitoring the voltage drop across a resistive element of the speaker driver circuit 300. Accordingly, in certain aspects a voltage signal can be obtained and then translated into a corresponding current signal based on a known resistance that the voltage signal is measured across, for example the impedance of the speaker. The circuitry and/or one or more processors and one or more memories configured may be further configured to detect a presence of a blockage of the speaker port based on the current signal, I(t).

In certain aspects, detection of the presence of a blockage of the speaker port may be determined in combination with the digital signal processing component 310. For example, the mobile phone 102 may include digital signal processing circuit (DSP circuit 312) and/or a processing system that is configured to implement a digital signal processing component 310. The digital signal processing component 310 may be configured to calculate a Kms value based on the electrical signal driving the speaker output. For example, the digital signal processing component 310 may be configured to calculate the following equations in determining the Ktot_0(n), which is the Kms value at a point in time.

Cbox(P)=Sd\hat{ }2*CFV*CBV/(CFV+CBV) Equation 1

Cbox(P) is the pressure within the speaker box 330 which includes the speaker 210, 212 and the speaker port 110. The pressure within the speaker box 330 depends on Sd\hat{ }2 which is the square of the surface of the diaphragm of the speaker; CFV, which is the cubic foot volume, also referred to as the internal volume of the speaker box 330 not including the volume of any internal components that displace air inside the speaker box 330; and CBV, which is the closed box volume of the speaker box 330 including any space occupied by internal components like bracing and the speaker itself.

Cms(x) refers to suspension compliance, a measure of how easily the speaker's suspension moves. Cms is the inverse of stiffness (Kms). The voice coil (the electromagnet) interacts with the permanent magnet, causing the cone to move. This movement is dictated by the stiffness (or compliance) of the speaker's suspension, as measured by Cms.

Ctotal(x) refers to total compliance of the speaker. This can be determined by Equation 2.

Ctotal(x)=Cms(x)*Cbox(P)/(Cms(x)+Cbox(P)) Equation 2

Since Cms is the inverse of stiffness (Kms), Ktotal(x) can be determined by Equation 3.

Ktotal(x)=1/Ctotal(x)=Ktot_0+Ktot_1*x+Ktot_2*x\hat{ }2+Ktot_3*x\hat{ }3+Ktot_5*x\hat{ }4 Equation 3.

In certain aspects, the stiffness can be expressed as a polynomial as depicted in Equation 3.

Speaker stiffness refers to the rigidity of a cone's material. A stiffer cone is more resistant to flexing and vibration, leading to a clearer, less distorted sound. The stiffness of a cone material is crucial in determining its ability to accurately reproduce sound waves.

Additionally, the velocity in the electrical domain and the mechanical domain need to be determined. Equations 4 and 5 express how the respective velocities may be determined.

v_elc(t)=(u(t)−Re(t)−Le(x)*di(t)/dt)/Bl(x) Equation 4

v_mec(t)=(Bl(x)*i(t)−0.5*i(t)\hat{ }2*dLe(x)/dx)/Zmec(x,v,t) Equation 5

The velocity refers to the speed at which the speaker cone moves. This velocity is crucial for understanding and predicting the low-frequency performance of a speaker and its interaction with an enclosure.

Bl refers to the speaker force factor or strength of the motor. Higher Bl values mean larger forces are generated by electrical current flowing through the voice coil. It is the product of B (magnetic gap field strength)×L (Length of voice coil wire in the magnetic gap field).

Re is the equivalent resistance value in the circuit. Le is the equivalent inductance value in the circuit. Finally, u(t) is the input electrical signal for driving the speaker and generating the sound output.

The term “i(t)” is the current value that may be directly measured from the speaker driver circuit 300.

e(n)=v_elc(n)−v_mec(n) Equation 6

Equation 6 may be utilized to minimize the error between the velocities.

J(n)=E(e(n)\hat{ }2) Equation 7

Ktot_0(n)=Ktot_0(n−1)−mu*∇_Kt_0(J(n)) Equation 8

Ktot_0(n) refers to the adaptation of the stiffness of speaker. This can change in value when the speaker port 110, 112 becomes block, thus providing an indication of the presence of a blockage. The Ktot_0(n) (or Kms value as referred to herein) is determined based on the previous Ktot_0(n−1) and the gradient descent as expressed in Equation 8.

As depicted in diagram 120 depicted in FIG. 1, when the speaker port 110 or 112 corresponding to the speaker is blocked, the Kms value increases beyond a Kms threshold (e.g., the first threshold 122). Utilizing a digital signal processing component 310 is one example process for detecting a blockage of a speaker port.

In certain aspects, the DSP circuit 312 may be communicatively coupled to a ML classifier 314. The ML classifier 314 may receive the Kms value and utilize that value to predict the presence of a blockage and/or the type of blockage, such as a finger, a shower, submersion, debris, or the like. The ML classifier 314 may be a model or machine learning algorithm such as a logistic regression model or algorithm, a Naive Bayes model or algorithm, a K-Nearest Neighbors model or algorithm, a decision tree model or algorithm, a Support Vector Machine, or other type of classifier model.

In certain aspects, other processes for determining and detecting the presence of a blockage of the speaker port. For example, the mobile phone 102 may include a processing system that is configured to implement a machine learning model (ML model) 322 configured to predict the presence of a blockage of the speaker port. For example, in certain aspects a current signal, I(t), and/or a voltage signal, V(t), may be obtained, for example, through measurement. The current signal, I(t), and/or the voltage signal, V(t), may be input into the ML model 322. The ML model 322 may be a model that is trained and configured to ingest at least a measurement value from the speaker driver circuit 300, such as the current signal, I(t), and/or the voltage signal V(t) and predict whether there is a presence of a blockage of the speaker port. The ML model 322 can be trained by feeding a first set of one or more electrical signals associated with audio output to the speaker that corresponds to blocked speaker ports and a second set of one or more electrical signals that correspond to unblocked speaker ports. The ML model 322 can be configured to learn patterns from each of the respective sets of one or more electrical signals in order to generate predictions corresponding to when a speaker port is blocked or unblocked. The ML model 322 may be a supervised, an unsupervised, a semi-supervised, or a reinforcement learning model.

In certain aspects, the processing system of the mobile phone 102 may be further configured to classify the type of blockage. For example, the type of blockage may be classified based on the Kms value exceeding one or more threshold values or the ML model 322 predicting the classification of the type of blockage based on the sets of electrical signals used for trained being further annotated to include the type of blockage associated with each of the respective electrical signals. In certain aspects, the processing system may be configured to classify the type of blockage of the speaker as a first type of blockage based on the Kms of the speaker being greater than a first threshold 122 (FIG. 1) and less than a second threshold 124 (FIG. 1). The processing system may be configured to classify the type of blockage of the speaker as a second type of blockage based on the Kms of the speaker being greater than the second threshold. In some instances, the first type of blockage may be material debris that has impacted in, on, or around the speaker port. While the second type of blockage may be the presence of a liquid in, on, or around the speaker port. For example, a liquid, such as water, may at least partially fill the speaker port cavity causing the speaker port to become at least partially blocked.

### Example Blockage Detection and Corrective Action Operations

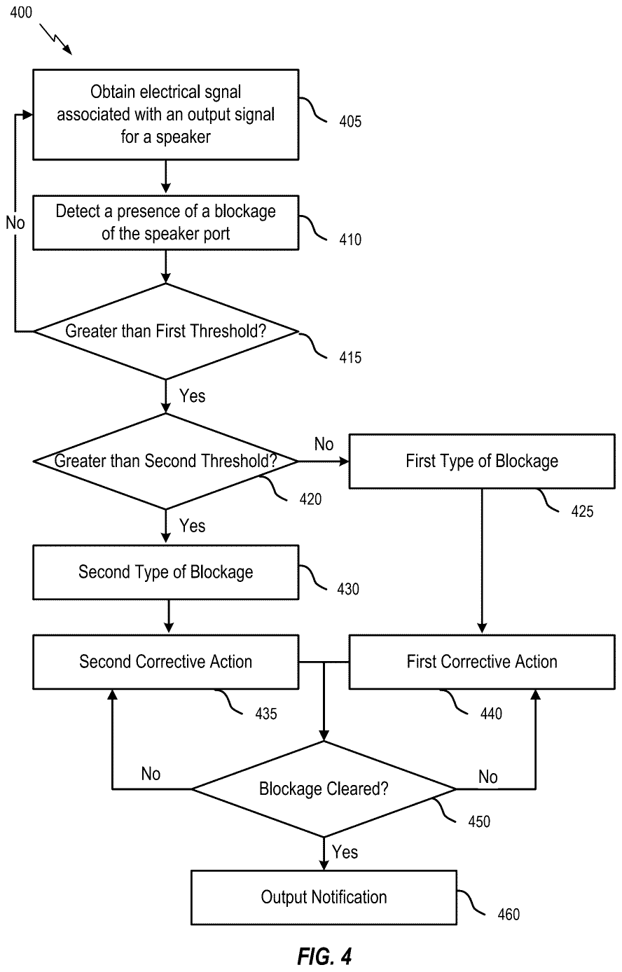

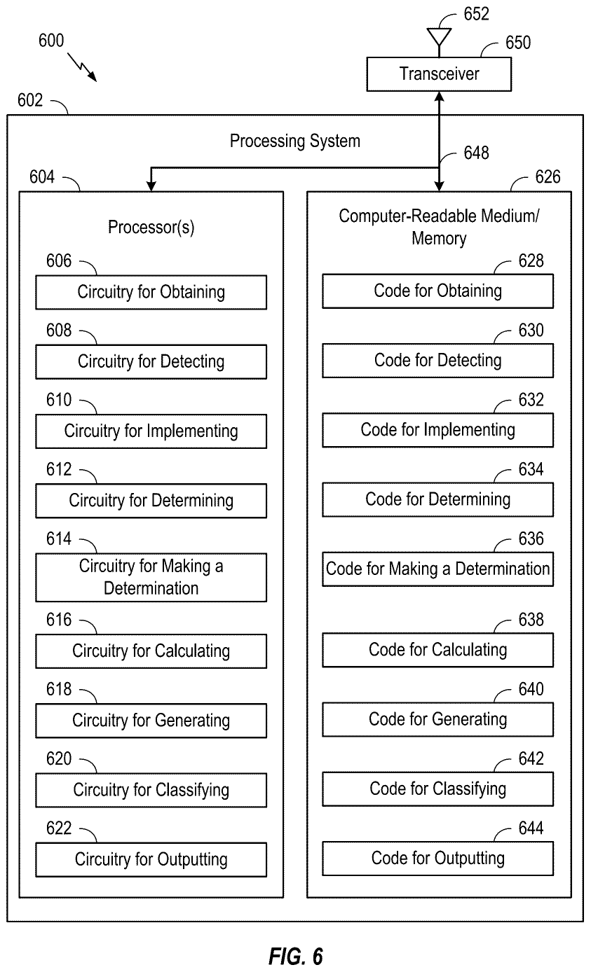

FIG. 4 shows an example method 400 for detecting the presence of a blockage and implementing one or more corrective actions with an apparatus, such as a mobile phone 102 of FIG. 1 or the apparatus 600 of FIG. 6. Aspects of the method 400 can be implemented by the computing device 240 comprising one or more processors 242 and a non-transitory computer readable memory 244 shown for example in FIG. 2 and/or the apparatus 600 of FIG. 6.

In certain aspects, for example as discussed herein, the processing system (e.g., the computing device 240 depicted and described with reference to FIG. 2) of the mobile phone 102 may be further configured to obtain an electrical signal, such as a current signal from a speaker driver circuit at block 405.

In certain aspects, the processing system, at block 410, may use the electrical signal to detect the presence of the blockage of the speaker port. In certain aspects, detection of the presence of the blockage may be determined by a digital signal processing component 310 (FIG. 3). In certain aspects, the presence of the blockage may be determined when the Kms value is greater than a first threshold at block 415. If the Kms value is greater than the first threshold, for example, “Yes” at block 415, then the processing system may proceed to block 420. If “No” at block 415, then the processing system may return to block 405 and continue to obtain electrical signals associated with the output signal for the speaker. In certain aspects, detection of the presence of the blockage may be determined by the ML model component 320 (FIG. 3). The ML model 322 of the ML model component 320 may predict the presence of the blockage and, in certain aspects, may also generate a Kms value.

When the processing system proceeds to block 420, the Kms value may be compared to a second threshold to determine whether the Kms value exceeds the second threshold or not. If the second threshold is not exceeded, “No” at block 420, the processing system may determine that the blockage is a first type of blockage at block 425. If the second threshold is exceeded, “Yes” at block 420, the processing system may determine that the blockage is a second type of blockage at block 430.

In certain aspects, the type of blockage may correspond to one or more corrective actions that can be implemented. For example, some types of blockages may be cleared or attempted to be cleared through automatic operations, such as a sequence of vibrations generated by the mobile phone 102, while other types of blockages may require manual intervention from the user of the mobile phone 102 to address. However, it should be understood that corrective action that is implemented does not need to be associated with a type of blockage. Instead, there are instances where one or more corrective actions may be automatically implemented by the mobile phone 102 to attempt to address the blockage, regardless of whether the type of blockage has been classified.

As depicted in FIG. 4, the method 400 associates the first type of blockage at block 420 with a first corrective action at block 440 and associates the second type of blockage at block 430 with a second corrective action at block 435. The first corrective action and/or the second corrective action may include causing the processing system to generate an output comprising visual alert on the display 256 of the mobile phone 102 (FIG. 2). The visual alert may include a notification that the speaker port is blocked. The visual alert may include instructions for correcting, such as cleaning the speaker port so that the blockage can be removed.

In certain aspects, the first corrective action and/or the second corrective action may include causing the processing system to generate an indication, such as a prompt with a selectable option to implement an automatic blockage clearing sequence. The automatic blockage clearing sequence may include causing the speaker to output a blockage clearing signal for a first period of time. For example, the blockage clearing signal may cause the speaker to output one or more frequencies at one or more volumes in one or more sequences to attempt to clear the blockage from the speaker port. In certain aspects, the blockage clearing signal may be associated with the type of blockage such that different types of blockages may have different blockage clearing signals.

In certain aspects, the processing system may implement the first corrective action or the second corrective action automatically in response to detecting the blockage of the speaker port. The processing system may not prompt the user before implementing the corrective action. Additionally, in certain aspects the processing system may not classify the type of blockage before implementing the corrective action.

In certain aspects, the processing system proceeds to block 450 to determine whether the blockage has been cleared. To determine whether the blockage has been cleared, the processing system may obtain a second electrical signal associated with the output signal for the speaker and detect the presence of a blockage of the speaker ports as discussed with reference to blocks 405 and 410 and the disclosure herein. If the blockage is determined to no longer be present at block 450, “Yes” at block 450, the method 400 may proceed to block 460. At block 460, the processing system may be configured to output a notification informing the user of the mobile phone 102 that the blockage has been cleared. However, if the blockage is determined to still be present at block 450, “No” at block 450, the method 400 include returning to one of blocks 435 or 440. Upon returning to either block 435 or 440, the processing system may implement the corrective action one or more additional times to attempt to clear the blockage. In certain aspects, if the processing system executes two or more iterations of the corrective action without success, the processing system may be configured to inform the user to take alternative actions to clear the blockage.

It should be noted that method 400 is only one example process for detecting the presence of a blockage and implementing one or more corrective actions with an apparatus, such as a mobile phone 102 of FIG. 1 or the apparatus 600 of FIG. 6. Variations of method 400 or alternative methods implementing similar processes discussed herein may be utilized for detecting the presence of a blockage and implementing one or more corrective actions.

### Example Operations

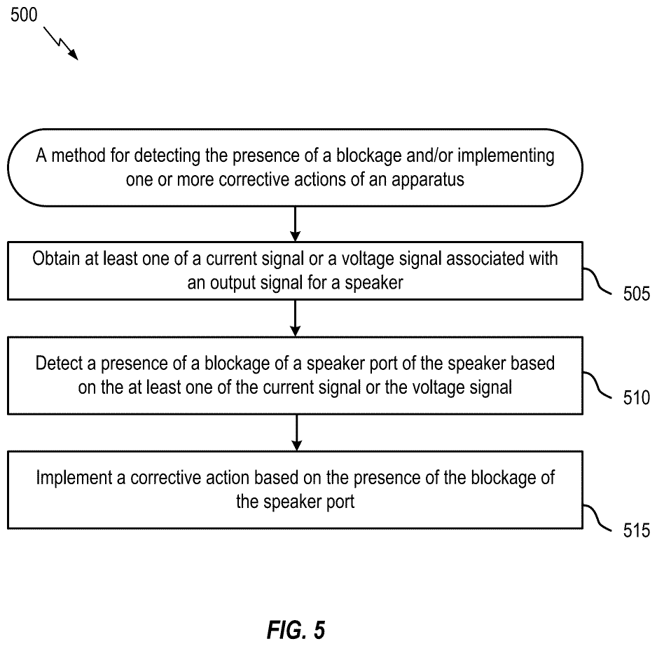

FIG. 5 shows an example method 500 for detecting the presence of a blockage and/or implementing one or more corrective actions of an apparatus, such as the mobile phone 102 of FIG. 1 or the apparatus 600 of FIG. 6. Aspects of the method 500 can be implemented by the computing device 240 comprising one or more processors 242 and a non-transitory computer readable memory 244 shown for example in FIG. 2 and/or the apparatus 600 of FIG. 6.

Method 500 begins at block 505 with obtaining at least one of a current signal or a voltage signal associated with an output signal for a speaker. The current signal and/or the voltage signal associated with the output signal for the speaker may be obtained through one or more sensors such as a current sensor, a voltage sensor, and/or a voltage sensor configured to measure a voltage drop across a resistive component having a known resistance value in the speaker driver circuit.

Method 500 proceeds to block 510 with detecting a presence of a blockage of a speaker port of the speaker based on the at least one of the current signal or the voltage signal. Detecting the presence of the blockage may utilize a digital signal processing component, a ML model component, or other component or components configured to determine changes in the speaker output signal of the speaker in response to a speaker port being blocked or partially blocked with debris as discussed herein.

Method 500 proceeds to block 515 with implementing a corrective action based on the presence of the blockage of the speaker port. The corrective action implemented by method 500 may include one or more different corrective actions. For example, in certain aspects, an automatic process may be implemented to attempt to clear the blockage. In certain aspects, a visual alert or an audible alert may be output from the apparatus, such as the mobile phone 102, to indicate to the user that a speaker port is blocked. The visual alert or the audible alert may provide instructions for clearing the blockage of the speaker port. In certain aspects, the corrective action may include one or more processes to clear and confirm whether the blockage has been cleared. If the blockage does not get cleared one or more additional corrective actions may be implemented.

In some aspects, detecting the presence of the blockage of the speaker port, comprises: determining a stiffness (e.g., a kinetic mass) of the speaker based on at least the current signal; and when the stiffness (e.g., kinetic mass) of the speaker exceeds a first threshold, making a determination of the presence of the blockage of the speaker port.

In some aspects, detecting the presence of the blockage of the speaker port, comprises: calculating a voltage signal corresponding to the current signal based on at least an impedance of the speaker; and generating, with a machine learning model configured to receive the current signal and the voltage signal, a prediction of the presence of the blockage of the speaker port.

In some aspects, detecting the presence of the blockage of the speaker port, comprises: generating, with a trained machine learning model configured to receive the voltage signal, a prediction of the presence of the blockage of the speaker port.

In some aspects, detecting the presence of the blockage of the speaker port, comprises: generating, with a trained machine learning model configured to receive the current signal, a prediction of the presence of the blockage of the speaker port.

In some aspects, method 500 further includes determining a stiffness of the speaker based on at least the current signal; and classifying a type of blockage of the speaker port based on a value of the stiffness of the speaker.

In some aspects, classifying the type of blockage of the speaker port, comprises: classifying the type of blockage of the speaker port as a first type of blockage based on the stiffness of the speaker being greater than a first threshold and less than a second threshold; or classifying the type of blockage of the speaker port as a second type of blockage based on the stiffness of the speaker being greater than the second threshold.

In some aspects, the blockage comprises an impaction of debris on or around the speaker.

In some aspects, the blockage comprises a presence of a liquid on or around the speaker.

In some aspects, method 500 further includes obtaining a second current signal associated with a second output signal for the speaker; determining that the blockage of the speaker port is removed based on the second current signal; and outputting a notification that the blockage is removed.

In some aspects, implementing the corrective action, the processing system is configured to cause the apparatus to output a visual alert.

In some aspects, the visual alert comprises one or more instructions for removing the blockage of the speaker port.

In some aspects, the visual alert comprises a prompt with a selectable option to implement an automatic blockage clearing sequence.

In some aspects, method 500 further includes receiving an indication that the selectable option to implement the automatic blockage clearing sequence is selected; and causing the speaker to output a blockage clearing signal for a first period of time.

In some aspects, method 500 further includes obtaining, during a second period of time after the first period of time, a second current signal associated with a second output signal for the speaker; determining that the blockage of the speaker port is not removed based on the second current signal; and causing the speaker to output the blockage clearing signal for a third period of time after the second period of time.

In some aspects, implementing the corrective action, comprises causing the speaker to output a blockage clearing signal for a first period of time.

In some aspects, method 500 further includes obtaining, during a second period of time after the first period of time, a second current signal associated with a second output signal for the speaker; and determining whether the blockage of the speaker port is removed based on the second current signal.

In some aspects, method 500, or any aspect related to it, may be performed by an apparatus, such as apparatus 600 of FIG. 6, which includes various components operable, configured, or adapted to perform method 500. Apparatus 600 is described below in further detail.

In some aspects, method 500 further includes the speaker communicatively coupled to the processing system, and wherein the speaker is configured to output a blockage clearing signal based on the corrective action.

In some aspects, method 500 further a display communicatively coupled to the processing system, and wherein the display is configured to output a visual alert based on the corrective action.

Note that FIG. 5 is just one example of a method, and other methods including fewer, additional, or alternative operations are possible consistent with this disclosure.

### Example Apparatus

FIG. 6 depicts aspects of an example apparatus 600 configured for detecting a blocked speaker port and/or implementing a corrective, such as the mobile phone 102 of FIG. 1. In some aspects, apparatus 600 may be the computing device 240 comprising one or more processors 242 and a non-transitory computer readable memory 244 shown for example in FIG. 2.

The apparatus 600 includes a processing system 602 coupled to a transceiver 650 (e.g., a transmitter and/or a receiver). The transceiver 650 is configured to transmit and receive signals for the apparatus 600 via an antenna 652, such as the various signals as described herein. The processing system 602 may be configured to perform processing functions for the apparatus 600, including processing signals received and/or to be transmitted by the apparatus 600.

The processing system 602 includes one or more processors 604 and a computer-readable medium/memory 626. In various aspects, the one or more processors 604 may be representative of the one or more processors of a computing device. The one or more processors 604 are coupled to a computer-readable medium/memory 626 via a bus 648. In some aspects, the computer-readable medium/memory 626 may be representative of the one or more memories (e.g., the non-transitory computer readable memory 244 described with respect to FIG. 2). The computer-readable medium/memory 626 is a non-transitory computer-readable medium/memory. In certain aspects, the computer-readable medium/memory 626 is configured to store instructions (e.g., computer-executable code), that when executed by the one or more processors 604, cause the one or more processors 604 to perform method 500 described with respect to FIG. 5, or any aspect related to it, including any operations described in relation to FIG. 5. Note that reference to a processor performing a function of apparatus 600 may include one or more processors performing that function of apparatus 600, such as in a distributed fashion.

In the depicted example, computer-readable medium/memory 626 stores code (e.g., executable instructions), including code for obtaining 628, code for detecting 630, code for implementing 632, code for determining 634, code for making 636, code for calculating 638, code for generating 640, code for classifying 642, and code for outputting 644. Processing of the code 628-644 may enable and cause the apparatus 600 to perform the method 500 described with respect to FIG. 5, or any aspect related to it. For example, in some aspects, code for obtaining 628 includes obtaining at least one of a current signal or a voltage signal associated with an output signal for a speaker. In some aspects, the code for obtaining 628 includes code for obtaining a second current signal associated with a second output signal for the speaker. In some aspects, the code for obtaining 628 includes code for obtaining, during a second period of time after the first period of time, a second current signal associated with a second output signal for the speaker.

In some aspects, code for detecting 630 includes code for detecting a presence of a blockage of a speaker port of the speaker based on the at least one of the current signal or the voltage signal. In some aspects, the code for detecting 630 includes code for determining 634 a stiffness (e.g., a kinetic mass) of the speaker based on at least the current signal, and code for making a determination 636 of the presence of the blockage of the speaker port when the stiffness of the speaker exceeds a first threshold. In some aspects, the code for determining 634 includes code for determining whether the blockage of the speaker port is removed based on the second current signal.

In some aspects, the code for detecting 630 further includes code for calculating 638 a voltage signal corresponding to the current signal based on at least an impedance of the speaker; and code for generating 640, with a machine learning model configured to receive the current signal and the voltage signal, a prediction of the presence of the blockage of the speaker port. In some aspects, the code for detecting 630 further includes code for generating 640, with a machine learning model configured to receive the voltage signal, a prediction of the presence of the blockage of the speaker port. In some aspects, the code for detecting 630 further includes code for generating 640, with a machine learning model configured to receive the current signal, a prediction of the presence of the blockage of the speaker port.

In some aspects, the code for implementing 632 includes code for implementing a corrective action based on the presence of the blockage of the speaker port. In some aspects, the code for implementing 632 causes the apparatus to output a visual alert, wherein the visual alert comprises one or more instructions for removing the blockage of the speaker port and/or a prompt with a selectable option to implement an automatic blockage clearing sequence. In some aspects, the code for implementing 632 includes code for causing the speaker to output a blockage clearing signal for a first period of time and/or for a third period of time after the second period of time.

In some aspects, the code for calculating 638 includes code for calculating a voltage signal corresponding to the current signal based on at least an impedance of the speaker. In some aspects, the code for generating 640 includes code for generating, with a machine learning model configured to receive the current signal and the voltage signal, a prediction of the presence of the blockage of the speaker port. In some aspects, the code for classifying 642 includes code for classifying the type of blockage of the speaker port as a first type of blockage based on the stiffness of the speaker being greater than a first threshold and less than a second threshold. In some aspects, the code for classifying 642 includes code for classifying the type of blockage of the speaker port as a second type of blockage based on the stiffness of the speaker being greater than the second threshold. In some aspects, the code for outputting 644 includes code for outputting a notification that the blockage is removed. In some aspects, the code for outputting 644 includes code for causing the speaker to output a blockage clearing signal for a first period of time. In some aspects, the code for outputting 644 includes causing the speaker to output the blockage clearing signal for a third period of time after the second period of time.

The one or more processors 604 include circuitry configured to implement (e.g., execute) the code stored in the computer-readable medium/memory 626, including circuitry for obtaining 606, circuitry for detecting 608, circuitry for implementing 610, circuitry for determining 612, circuitry for making a determination 614, circuitry for calculating 616, circuitry for generating 618, circuitry for classifying 620, and circuitry for outputting 622. Processing with circuitry 606-622 may enable and cause the apparatus 600 to perform the method 500 described with respect to FIG. 5, or any aspect related to it.

For example, in some aspects, the circuitry for obtaining 606 includes circuitry for obtaining a current signal associated with an output signal for a speaker. In some aspects, the circuitry for obtaining 606 includes circuitry for obtaining a second current signal associated with a second output signal for the speaker. In some aspects, the circuitry for obtaining 606 includes circuitry for obtaining, during a second period of time after the first period of time, a second current signal associated with a second output signal for the speaker.

In some aspects, circuitry for detecting 608 includes circuitry for detecting a presence of a blockage of a speaker port of the speaker based on the current signal. In some aspects, the circuitry for detecting 608 includes circuitry for determining 612 a stiffness of the speaker based on at least the current signal, and circuitry for making a determination 614 of the presence of the blockage of the speaker port when the stiffness of the speaker exceeds a first threshold. In some aspects, the circuitry for determining 612 includes circuitry for determining whether the blockage of the speaker port is removed based on the second current signal.

In some aspects, the circuitry for detecting 608 further includes circuitry for calculating 616 a voltage signal corresponding to the current signal based on at least an impedance of the speaker; and circuitry for generating 618, with a machine learning model configured to receive the current signal and the voltage signal, a prediction of the presence of the blockage of the speaker port.

In some aspects, the circuitry for implementing 610 includes circuitry for implementing a corrective action based on the presence of the blockage of the speaker port. In some aspects, the circuitry for implementing 610 causes the apparatus to output a visual alert, wherein the visual alert comprises one or more instructions for removing the blockage of the speaker port and/or a prompt with a selectable option to implement an automatic blockage clearing sequence. In some aspects, the circuitry for implementing 610 includes circuitry for causing the speaker to output a blockage clearing signal for a first period of time and/or for a third period of time after the second period of time.

In some aspects, the circuitry for calculating 616 includes circuitry for calculating a voltage signal corresponding to the current signal based on at least an impedance of the speaker. In some aspects, the circuitry for generating 618 includes circuitry for generating, with a machine learning model configured to receive the current signal and the voltage signal, a prediction of the presence of the blockage of the speaker port. In some aspects, the circuitry for classifying 620 includes circuitry for classifying the type of blockage of the speaker port as a first type of blockage based on the stiffness of the speaker being greater than a first threshold and less than a second threshold. In some aspects, the circuitry for classifying 620 includes circuitry for classifying the type of blockage of the speaker port as a second type of blockage based on the stiffness of the speaker being greater than the second threshold. In some aspects, the circuitry for outputting 622 includes circuitry for outputting a notification that the blockage is removed. In some aspects, the circuitry for outputting 622 includes circuitry for causing the speaker to output a blockage clearing signal for a first period of time. In some aspects, the circuitry for outputting 622 includes causing the speaker to output the blockage clearing signal for a third period of time after the second period of time.

More generally, means for communicating, transmitting, sending or outputting for transmission may include the one or more transceivers 650 and/or antenna 652 of the apparatus 600 in FIG. 6, and/or one or more processors 604 of the apparatus 600 in FIG. 6. Means for communicating, receiving or obtaining may include the one or more transceivers 650 and/or antenna 652 of the apparatus 600 in FIG. 6, and/or one or more processors 604 of the apparatus 600 in FIG. 6.

### Example Clauses

Implementation examples are described in the following numbered clauses:

Clause 1: A method for blocked speaker port detection of an apparatus, comprising: obtaining a current signal associated with an output signal for a speaker; detecting a presence of a blockage of a speaker port of the speaker based on the current signal; and implementing a corrective action based on the presence of the blockage of the speaker port.

Clause 2: The method of Clause 1, wherein detecting the presence of the blockage of the speaker port, comprises: determining a stiffness of the speaker based on at least the current signal; and when the stiffness of the speaker exceeds a first threshold, making a determination of the presence of the blockage of the speaker port.

Clause 3: The method of any one of Clauses 1-2, wherein detecting the presence of the blockage of the speaker port, comprises: calculating a voltage signal corresponding to the current signal based on at least an impedance of the speaker; and generating, with a machine learning model configured to receive the current signal and the voltage signal, a prediction of the presence of the blockage of the speaker port.

Clause 4: The method of any one of Clauses 1-3, further comprising: determining a stiffness of the speaker based on at least the current signal; and classifying a type of blockage of the speaker port based on a value of the stiffness of the speaker.

Clause 5: The method of Clause 5, wherein classifying the type of blockage of the speaker port, comprises: classifying the type of blockage of the speaker port as a first type of blockage based on the stiffness of the speaker being greater than a first threshold and less than a second threshold; or classifying the type of blockage of the speaker port as a second type of blockage based on the stiffness of the speaker being greater than the second threshold.

Clause 6: The method of any one of Clauses 1-5, wherein the blockage comprises an impaction of debris on or around the speaker.

Clause 7: The method of any one of Clauses 1-5, wherein the blockage comprises a presence of a liquid on or around the speaker.

Clause 8: The method of any one of Clauses 1-7, further comprising: obtaining a second current signal associated with a second output signal for the speaker; determining that the blockage of the speaker port is removed based on the second current signal; and outputting a notification that the blockage is removed.

Clause 9: The method of any one of Clauses 1-8, wherein implementing the corrective action, the processing system is configured to cause the apparatus to output a visual alert.

Clause 10: The method of Clause 9, wherein the visual alert comprises one or more instructions for removing the blockage of the speaker port.

Clause 11: The method of Clause 9, wherein the visual alert comprises a prompt with a selectable option to implement an automatic blockage clearing sequence.

Clause 12: The method of Clause 11, further comprising: receiving an indication that the selectable option to implement the automatic blockage clearing sequence is selected; and causing the speaker to output a blockage clearing signal for a first period of time.

Clause 13: The method of Clause 12, further comprising: obtaining, during a second period of time after the first period of time, a second current signal associated with a second output signal for the speaker; determining that the blockage of the speaker port is not removed based on the second current signal; and causing the speaker to output the blockage clearing signal for a third period of time after the second period of time.

Clause 14: The method of any one of Clauses 1-13, wherein implementing the corrective action, comprises causing the speaker to output a blockage clearing signal for a first period of time.

Clause 15: The method of Clause 14, further comprising: obtaining, during a second period of time after the first period of time, a second current signal associated with a second output signal for the speaker; and determining whether the blockage of the speaker port is removed based on the second current signal.

Clause 16: One or more apparatuses, comprising: one or more memories comprising executable instructions; and one or more processors configured to execute the executable instructions and cause the one or more apparatuses to perform a method in accordance with any one of Clauses 1-15.

Clause 17: One or more apparatuses configured for feature detection and extraction, comprising: one or more memories; and one or more processors, coupled to the one or more memories, configured to cause the one or more apparatuses to perform a method in accordance with any one of Clauses 1-15.

Clause 18: One or more apparatuses configured for feature detection and extraction, comprising: one or more memories; and one or more processors, coupled to the one or more memories, configured to perform a method in accordance with any one of Clauses 1-15.

Clause 19: One or more apparatuses, comprising means for performing a method in accordance with any one of Clauses 1-15.

Clause 20: One or more non-transitory computer-readable media comprising executable instructions that, when executed by one or more processors of one or more apparatuses, cause the one or more apparatuses to perform a method in accordance with any one of Clauses 1-15.

Clause 21: One or more computer program products embodied on one or more computer-readable storage media comprising code for performing a method in accordance with any one of Clauses 1-15.

Clause 22: One or more apparatuses configured for feature detection and extraction, comprising: a processing system that includes one or more processors and one or more memories coupled with the one or more processors, the processing system configured to cause the one or more apparatuses to perform a method in accordance with any one of Clauses 1-15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising: a processing system that includes one or more processors and one or more memories coupled with the one or more processors, the processing system configured to cause the apparatus to:
obtain at least one of a current signal or a voltage signal associated with an output signal for a speaker;
detect a presence of a blockage of a speaker port of the speaker based on the at least one of the current signal or the voltage signal; and
implement a corrective action based on the presence of the blockage of the speaker port.

2. The apparatus of claim 1, wherein to detect the presence of the blockage of the speaker port, the processing system is configured to cause the apparatus to:
determine a stiffness of the speaker based on at least the current signal; and
when the stiffness of the speaker exceeds a first threshold, make a determination of the presence of the blockage of the speaker port.

3. The apparatus of claim 1, wherein to detect the presence of the blockage of the speaker port, the processing system is configured to cause the apparatus to: generate, with a trained machine learning model configured to receive the voltage signal, a prediction of the presence of the blockage of the speaker port.

4. The apparatus of claim 1, wherein to detect the presence of the blockage of the speaker port, the processing system is configured to cause the apparatus to: generate, with a trained machine learning model configured to receive the current signal, a prediction of the presence of the blockage of the speaker port.

5. The apparatus of claim 1, wherein the processing system is further configured to cause the apparatus to:
determine a stiffness of the speaker based on at least the current signal; and
classify a type of blockage of the speaker port based on a value of the stiffness of the speaker.

6. The apparatus of claim 5, wherein to classify the type of blockage of the speaker port, the processing system is further configured to cause the apparatus to at least one of:
classify the type of blockage of the speaker port as a first type of blockage based on the stiffness of the speaker being greater than a first threshold and less than a second threshold; or
classify the type of blockage of the speaker port as a second type of blockage based on the stiffness of the speaker being greater than the second threshold.

7. The apparatus of claim 1, wherein the blockage comprises an impaction of debris on or around the speaker.

8. The apparatus of claim 1, wherein the blockage comprises a presence of a liquid on or around the speaker.

9. The apparatus of claim 1, wherein the processing system is further configured to cause the apparatus to:
obtain a second current signal associated with a second output signal for the speaker;
determine that the blockage of the speaker port is removed based on the second current signal; and
output a notification that the blockage is removed.

10. The apparatus of claim 1, wherein to implement the corrective action, the processing system is configured to cause the apparatus to output a visual alert.

11. The apparatus of claim 10, wherein the visual alert comprises one or more instructions for removing the blockage of the speaker port.

12. The apparatus of claim 10, wherein the visual alert comprises a prompt with a selectable option to implement an automatic blockage clearing sequence.

13. The apparatus of claim 12, wherein the processing system is further configured to cause the apparatus to:
receive an indication that the selectable option to implement the automatic blockage clearing sequence is selected; and
cause the speaker to output a blockage clearing signal for a first period of time.

14. The apparatus of claim 13, wherein the processing system is further configured to cause the apparatus to:
obtain, during a second period of time after the first period of time, a second current signal associated with a second output signal for the speaker;
determine that the blockage of the speaker port is not removed based on the second current signal; and
cause the speaker to output the blockage clearing signal for a third period of time after the second period of time.

15. The apparatus of claim 1, wherein to implement the corrective action, the processing system is configured to cause the apparatus to cause the speaker to output a blockage clearing signal for a first period of time.

16. The apparatus of claim 15, wherein the processing system is further configured to cause the apparatus to:
obtain, during a second period of time after the first period of time, a second current signal associated with a second output signal for the speaker; and
determine whether the blockage of the speaker port is removed based on the second current signal.

17. The apparatus of claim 1, further comprising the speaker communicatively coupled to the processing system, wherein the speaker is configured to output a blockage clearing signal based on the corrective action.

18. The apparatus of claim 1, further comprising a display communicatively coupled to the processing system, wherein the display is configured to output a visual alert based on the corrective action.

19. A method for blocked speaker port detection of an apparatus, comprising:
obtaining at least one of a current signal or a voltage signal associated with an output signal for a speaker;
detecting a presence of a blockage of a speaker port of the speaker based on the at least one of the current signal or the voltage signal; and
implementing a corrective action based on the presence of the blockage of the speaker port.

20. The method of claim 19, wherein detecting the presence of the blockage of the speaker port, comprises:
determining a stiffness of the speaker based on at least the current signal; and
when the stiffness of the speaker exceeds a first threshold, making a determination of the presence of the blockage of the speaker port.
